(19) United States
(12) Patent Application Publication
(10) Pub. No.: US 2017/0183490 A1
(43) Pub. Date: Jun. 29, 2017

(54) POLYVINYLCHLORIDE/POLYOLEFIN COMPOSITION

(71) Applicant: SABIC Global Technologies B.V., Bergen op Zoom (NL)

(72) Inventors: Abdulhamid Mokdad, Riyadh (SA); Adbulhadi Al-Shehri, Riyadh (SA); Mohamed Zerfa, Riyadh (SA)

(21) Appl. No.: 15/313,189

(22) PCT Filed: May 18, 2015
(86) PCT No.: PCT/EP2015/060887

§ 371 Date: Nov. 22, 2016

(30) Foreign Application Priority Data
May 23, 2014 (EP) 14169558.5

(51) Int. Cl. C08L 27/06

(52) U.S. Cl. CPC C08L 27/06; C08L 2205/03; C08L 2205/035; C08L 2205/08; C08L 2205/05

(57) ABSTRACT

The invention is directed to a composition, and to an article made from said composition. The composition of the invention comprises a blend of: (A) polyvinylchloride; (B) polyolefin modified to have one or more carboxyl groups; and (C) a copolymer containing one or more moieties that are miscible with polyvinylchloride and one or more epoxy groups.

The invention is directed to a composition, and to an article made from said composition. More in particular, the invention relates to a composition comprising a compatibilised blend of polyvinylchloride and polyolefin.

Due to the shortage of crude oil and environment considerations, the polymer fabrication industry is paying increasing attention to the possibility of recycling polymer wastes. The key problem to be solved before processes for recycled products become economic is the inferior mechanical properties of polymer blends formed from the common thermoplastics. Among them, polyvinyl chloride (PVC) and polyolefins (POs, including polyethylene, PE, and polypropylene, PP) have the largest scale fabrication and application. Blends of polyvinylchloride and polyolefins possess very poor mechanical properties because of their poor miscibility and for this reason, the study of polyvinylchloride/polyolefin blends is of interest in both industrial and academic fields.

Due to difficulties in compatibilising these blends this has not led to commercially available systems containing high concentrations of the two major components. Polyvinylchloride/polyolefin blends do not compatibilise satisfactorily because of the poor adhesion of the phases due to the thermodynamic incompatibility.

In the prior art compatibilisers have been suggested.

EP0285824 discloses a polyblend chiefly of polyvinylchloride and a minor amount of polyolefin, which polyblend is compatibilized with co-compatibilizers, the first compatbilizer being chlorinated polyethylene and the second being a graft copolymer of a polyolefin. This reference does not disclose an in-situ reaction between the co-compatibilizers to reinforce the interface.

JP19920233257 discloses a composition incorporating a total of 100 pts.wt. of a base resin composed of (A) 1-99 pts.wt. of vinyl chloride-based resin and/or styrene-based resin and (B) 99-1 pts.wt. of an olefin resin with (C) 0-50 pts.wt. of a compatibilizer for compatibilizing the component A with the component B, (D) 0.1-50 pts.wt. of a graft copolymer obtained by graft polymerization of (d-1) 5-10 pts.wt. of a combination of (1) 0.01-50 wt. % of an epoxy group-bearing vinyl compound and (2) 50-99.99 wt. % of another vinyl compound to (d-2) 40-95 pts.wt. of a rubbery polymer and (E) 1-200 pts.wt. of a heat resistance improver obtained by copolymerization between (e-1) 0.01-50 wt. % of an epoxy group-bearing vinyl compound and (e-2) 50-99.99 wt. % of another vinyl compound.

JP19920220459 discloses a composition obtained by blending 100 pts.wt. total amount composed of (A) 1-99 pts.wt. vinyl chloride-based resin and(or) styrenic resin and (B) 99-1 pt.wt. olefinic resin such as PP with (C) 0-50 pts.wt. compatibilizing agent for the components (A) and (B), and (D) 1-200 pts.wt. heat resistance improver comprising a copolymer composed of (i) 0.01-50 wt. % vinyl compound having epoxy group and (ii) 50-99.99 wt. % other copolymerizable vinyl compounds.

In the prior art, various methods have also been suggested for the reactive compatibilisation of such immiscible blends for demanding applications. The mechanical properties and the technical performance of the immiscible blends would be more nearly additive if the interfacial zone is strengthened. One way to do this is to add interfacially active agents to the immiscible mixture. Thus, the interfacial energy between the immiscible phases is reduced ensuring a finer dispersion upon mixing and higher stability against phase separation.

Paul et al. (Polym. Eng. Sci. 1973, 13(3), 202-208) showed some improvement in mechanical properties when chlorinated polyethylene was used as a compatibiliser additive. This effect was said to derive from the graded molecular structure acquired during chlorination. In a related study, Locke et al. (Polym. Eng. Sci. 1973, 13(4), 308-318) concluded that the interaction of chlorinated polyethylene with polyethylene derives from compatibility of rather long methylene sequences in chlorinated polyethylene with the polyethylene which results in good adhesive bonding. The interaction of chlorinated polyethylene with polyvinylchloride was attributed to good mutual adhesion between similar polar materials. They also reported that the addition of chlorinated polyethylene to polyvinylchloride/polyethylene blends is accompanied by a decrease in component domain size.

While the use of chlorinated polyethylene as a compatibiliser for polyvinylchloride/polyethylene blends considerably reduces the surface tension between the two polymers, this reduction is unfortunately not sufficient to create a tangible compatibilisation. Although the domains of the two polymers are reduced in size, the interface forces are relatively weak and prevent further significant improvements in mechanical properties.

Another approach focused on adding a crosslinking agent to the blend. Nakamura et al. (J. Mater. Sci. 1986, 21(12), 4485-4488), for instance, disclosed addition of peroxide to a polyvinylchloride/polyethylene blend to give a co-crosslinked blend with a uniform dispersion of small polyethylene particles and with an improved mechanical properties.

Despite these prior art efforts, there remains a need for blends of polyvinylchloride and polyolefins having improved mechanical properties.

An objective of the invention is to address this need in the art and overcome one or more of the disadvantages faced in the prior art approaches.

The inventors found that this objective can, at least in part, be met by providing a blend of polyvinylchloride and polyolefin, wherein said blend is compatibilised with a specific copolymer.

Accordingly, in a first aspect the invention is directed to a composition comprising a blend of
(A) polyvinylchloride;
(B) polyolefin modified to have one or more carboxyl groups; and
(C) a copolymer containing one or more moieties that are miscible with polyvinylchloride and one or more epoxy groups.

The inventors surprisingly found that in the composition of the invention the interfaces forces are reinforced through an in situ reaction between epoxy and carboxyl groups. As a result, both the mixing and the mechanical properties improve considerably. Without wishing to be bound by any theory, it is believed that the considerably improvement in mechanical properties is a result of an increase of the interaction forces at the interfaces between the polyolefin and the polyvinylchloride.

The term “polyvinylchloride” as used in this application is meant to refer to both homopolymers of polyvinylchloride as well as co- and ter-polymers of vinyl chloride with comonomers such as vinyl acetate, vinyl formate, alkyl vinyl ethers, ethylene, propylene, butylenes, vinylidene chloride, alkyl acrylates and alkyl methacrylates, alkyl maleates, alkyl fumarates, and the like. Preferably at least 80%, more preferably at least 90%, and even more preferably 100% of the monomers to be polymerized will be vinyl chloride monomer. These resins typically have a number average molecular weight of 35 000-120 000 g/mol (as determined by ASTM D5296-97), preferably 45 000-75 000 g/mol. Inherent viscosity (as measured by ASTM D1243-60; Method A) will generally be in the range of 0.5-1.5, preferably in the range of 0.7-1.2. The method of preparation of these resins is not critical and, for example, any of the well known suspension techniques may be employed.

The term “polyolefin” is well known to the skilled person and generally refers to a class of homopolymers or copolymers produced from one or more olefins (also called an alkene with the general formula CnH2n) as a monomer. It is preferred in accordance with the invention that the polyolefin is a homopolymer of olefin or a copolymer of two or more olefins. More preferably, the polyolefin is a homopolymer of olefin. Thus, within the family of polyolefins, various polyethylene homopolymers and copolymers can be used, as well as polypropylene homopolymers and copolymers and high melt strength polypropylenes constructed through polymerisation or irradiation techniques. For example, polyethylene homopolymers can include (but are not limited to) low density polyethylene (LDPE) and high density polyethylene (HDPE). Although strictly speaking not polyolefins, for the purpose of the present invention copolymers of ethylene and vinyl acetate (EVA), and copolymers of ethylene and vinyl alcohol (EVOH) are also considered as polyolefins. Ethylene/α-olefin copolymers are copolymers of ethylene with one or more comonomers selected from C₃-C₂₀ α-olefins, such as 1-butene, 1-pentene, 1-hexene, 1-octene, methyl pentene, and the like, including linear low density polyethylene (LLDPE), linear medium density polyethylene (MDPE), very low density polyethylene (VLDPE), and ultra low density polyethylene (ULDPE). In some embodiments, suitable polyolefins can be derived from petroleum-based resources and/or emerging bio-based resources.

Polyolefins such as polyethylenes are commonly differentiated based on the density which results from their numbers of chain branches per 1000 carbon atoms in the polyethylene main chain in the molecular structure. Branches typically are C₃-C₈ olefins, and which are preferably butene, hexene or octene. For example, HDPE has very low numbers of short chain branches (less than 20 per 1000 carbon atoms), resulting in a relatively high density, i.e. a density of 0.94-0.97 gm/cc. LLDPE has more short chain branches, in the range of 20-60 per 1000 carbon atoms with a density of 0.91-0.93 gm/cc. LDPE with a density of 0.91-0.93 gm/cc has long chain branches (20-40 per 1000 carbon atoms) instead of short chain branches in LLDPE and HDPE. ULDPE has a higher concentration of short chain branches than LLDPE and HDPE, i.e. in the range of 80-250 per 1000 carbon atoms and has a density of 0.88-0.91 gm/cc.

Illustrative copolymer and terpolymers include copolymers and terpolymers of α-olefins with other olefins such as ethylene-propylene copolymers; ethylene-butene copolymers; ethylene-pentene copolymers; and ethylene-hexene copolymers. The above polyolefins may be obtained by any known process. The polyolefin may have a number average molecular weight of 1000-1 000 000 g/mol (as determined by ASTM D 6474-99), and preferably 10 000-500 000 g/mol. Preferred polyolefins are polyethylene, polypropylene, polybutylene and copolymers, and blends thereof. The most preferred polyolefin is polyethylene.

The composition of the invention comprises a blend of polyvinylchloride and polyolefin that is modified to have one or more carboxyl groups (i.e. —COOH). Such modified polyolefins are commercially available. More in particular, the polyolefin that is modified to have one or more carboxyl groups suitably refers to those polymers obtained by modifying polyolefins with unsaturated carboxylic acids such as acrylic acid, methacrylic acid, maleic acid, fumaric acid, maleic anhydride, itaconic anhydride, etc. Such modified polyolefins can, for instance be obtained by a process of adding an unsaturated carboxylic acid (such as up to 5 mol %, preferably 0.5-2 mol %) and a slight quantity of an organic peroxide to a polyolefin, followed by melt-kneading the mixture by means of an extruder. These modifications are well-known in the art. Further, various polyolefins modified to have one or more carboxyl groups are commercially available. Some examples of commercially available modified polyolefins include Polybond® 1001, Polybond® 1002 and Polybond® 1009 (all available from Addivant).

In a preferred embodiment, the polyolefin modified to have one or more carboxyl groups is a modified polyethylene and/or modified polypropylene, preferably a modified high density polyethylene and/or modified polypropylene.

In addition to the polyvinylchloride and the polyolefin modified to have one or more carboxyl groups, the composition of the invention further comprises a copolymer containing one or more moieties that are miscible with polyvinylchloride and one or more epoxy groups. This copolymer acts as a compatibiliser for the otherwise immiscible mixture of polyvinylchloride and polyolefin.

The copolymer contains one or more moieties that are miscible with polyvinyl chloride. A preferred example of such a moiety is a polymethylmethacrylate, but other polar moieties that are readily miscible with polyvinylchloride can be used as well. Some other examples include nitrile butadiene rubber, polycaprolactone, polyethylene vinyl acetate, poly(ethylene-vinylacetate-carbon monoxide)terpolymer, and the like.

Further, the copolymer also contains one or more epoxy groups. Typically, such epoxy groups can be introduced into the copolymer by polymerising in the presence of epoxy group-containing monomers. For example the epoxy group may be introduced in the form of a glycidyl ether group, a glycidyl ester group, a glycidylamino group, or a group derived from a reaction of an N-heterocycle-containing compound and epichlorohydrin as well as epoxy group, preferably in the form of a glycidyl ether or a glycidyl ester group. Some examples of such epoxy-group containing monomers include alkyl glycidyl ethers (such as vinyl glycidyl ether, isopropenyl glycidyl ether, allyl glycidyl ether, methallyl glycidyl ether, butenyl glycidyl ether and oleyl glycidyl ether), cycloalkyl glycidyl ethers, alkyl-substituted phenyl glycidyl ethers and derivatives thereof (such as 4-vinyl cyclohexyl-glycidyl ether, cyclohexenylmethyl glycidyl ether, o-allylphenyl glycidyl ether and p-vinylbenzyl glycidyl ether), monoepoxide compounds of the diene type monomers (such as butadiene monoepoxide, chloroprene monoxide, 3,4-epoxy-1-pentene, 4,5-epoxy-1-pentene, 4,5-epoxy-2-pentene, 4,5-epoxy-1-hexene, 5,6-epoxy-1-hexene, 5,6-epoxy-2-hexene, 3,4-epoxy-1-vinylcyclohexene and divinylbenzene monoxide), and alkyl glycidyl esters (such as glycidyl acrylate, glycidyl methacrylate, crotonic acid glycidyl ester and oleic acid glycidyl ester).

In the composition of the invention one or more carboxyl groups of the modified polyolefin react in situ with one or more epoxy groups of the copolymer. Hence, in an embodiment one or more of the epoxy groups on the copolymer have undergone a ring-opening reaction with one or more carboxylic groups on the modified polyolefin. This reaction ensures phases interactions reinforcements

In a preferred embodiment, the copolymer comprises one or more monomers selected from the group consisting of methyl acrylate, methyl methacrylate, ethyl acrylate, ethyl methacrylate, glycidyl acrylate, and glycidyl methacrylate. More preferably, the copolymer comprise one or more monomers selected from methyl methacrylate, glycidyl methacrylate, ethyl acrylate. Even more preferably, the copolymer is a copolymer of methyl methacrylate, glycidyl methacrylate and ethyl acrylate.

In a preferred embodiment, the copolymer is a copolymer of methyl methacrylate, glycidyl methacrylate and ethyl acrylate, and the methyl methacrylate is present in an amount of 60-85 wt. % based on total weight of the copolymer, the glycidyl methacrylate is present in an amount of 10-40 wt. % based on total weight of the copolymer, and the ethyl acrylate is present in an amount of 1-5 wt. % based on total weight of the copolymer.

The relative amounts of the components in the composition of the invention can vary. Preferably, however, the polyvinylchloride is the major component in the blend and forms a matrix, in which domains of the polyolefin are compatibilised by the copolymer.

An example of a preferred blend of the invention comprises:
(A) 40-85 wt. % based on total weight of the blend of said polyvinylchloride;
(B) 3-15 wt. % based on total weight of the blend of said polyolefin modified to have one or more carboxyl groups; and
(C) 3-15 wt. % based on total weight of the blend of said copolymer.

A more preferred example of a blend of the invention comprises:
(A) 45-80 wt. % based on total weight of the blend of said polyvinylchloride;
(B) 4-12 wt. % based on total weight of the blend of said polyolefin modified to have one or more carboxyl groups; and
(C) 4-12 wt. % based on total weight of the blend of said copolymer.

An even more preferred example of a blend of the invention comprises:
(A) 50-75 wt. % based on total weight of the blend of said polyvinylchloride;
(B) 5-10 wt. % based on total weight of the blend of said polyolefin modified to have one or more carboxyl groups; and
(C) 5-10 wt. % based on total weight of the blend of said copolymer. The blend of the invention can further comprise a polyolefin (D).
   Preferably such polyolefin is present in an amount of 5-35 wt. % based on total weight of the blend, more preferably 10-30 wt. %, even more preferably 15-25 wt. %.

Preferably, the optional polyolefin (D) is selected from a polyethylene and/or polypropylene, more preferably high density polyethylene, and/or polypropylene.

Advantageously, the blend of the invention can further comprise a chlorinated polyolefin (E). The presence of such a chlorinated polyolefin further improves the mechanical properties of the composition, in particular elongation to break. It is believed that this improvement is the result of a reduction of the surface tension between polyvinylchloride and polyolefin caused by the chlorinated polyolefin. The inventors found that the presence of a chlorinated polyolefin works synergistically with the improvement in mechanical properties by the copolymer compatibiliser. Preferably, such chlorinated polyolefin is present in an amount of 3-15 wt. % based on total weight of the blend of said copolymer, more preferably 4-12 wt. %, even more preferably 5-10 wt. %. Chlorinated polyolefins are commercially available, such as Tyrin™ BH 9000 which is available from Dow Chemical.

Preferably, the optional chlorinated polyolefin (E) is selected from a chlorinated polyethylene and/or chlorinated polypropylene. More preferably, the chlorinated polyolefin (E) is a chlorinated polyethylene.

Apart from the blend, the composition of the invention can further comprise one or more additives (such as from 0.0001-20 wt. %, based on total weight of the composition). Such additives can, for example, include plasticisers, stabilisers including viscosity stabilisers and hydrolytic stabilisers, antioxidants, ultraviolet ray absorbers, anti-static agents, dyes, pigments or other colouring agents, inorganic fillers, fire-retardants, lubricants, reinforcing agents such as glass fibre and flakes, foaming or blowing agents, processing aids, anti-block agents, release agents, fusion aid, process aid, calcium carbonate, calcium stearate, titanium dioxide, stearic acid, paraffin wax, or combinations of two or more thereof.

Compositions can be produced by any methods known to the person skilled in the art such as standard mixing practices. This can be accomplished in a one-step or a multi-step process.

The composition of the invention allows the fabrication of articles with improved mechanical properties. The composition can be formed in to shaped articles using methods such as injection moulding, compression moulding, overmoulding, or extrusion. Optionally, formed articles can be further processed. For example, pellets, slugs, rods, ropes, sheets and moulded articles of the invention may be prepared and used for feedstock for subsequent operations, such as thermoforming operations, in which the article is subjected to heat, pressure and/or other mechanical forces to produce shaped articles.

In a further aspect, the invention is directed to an article made from the composition of the invention.

The article of the invention can have an advantageous elongation at break of 10% or more, such as in the range of 10-45%, preferably in the range of 20-45%, more preferably in the range of 25-45% as measured in accordance with ISO 527.

The article of the invention can further have an advantageous tensile strength of 20 MPa or more, such as in the range of 20-40 MPa, or in the range of 22-35 MPa as measured in accordance with ISO 527.

The article of the invention can desirably achieve a combination of high elongation at break and at the same time a high tensile strength. The high elongation at break is induced by the polyolefin component while the high tensile strength is induced by the polyvinylchloride component.

The article of the invention may be in the form of a compact and foamed extruded sheet. The article of the invention can be used, for instance, in house doors, kitchen cabinets, and furniture articles (tables, chairs and the like). The article of the invention may also be used in electrical ducts, corrugated pipes or sewage pipes. The pipes may be core-shell pipes with a foamed core and a compact shell.

In a further aspect the invention relates to the use of the compatibiliser herein disclosed for compatibilising a blend of polyvinylchloride and polyolefin.

The invention will now be further illustrated by means of the following examples, which are not intended to limit the scope of protection in any manner.

### EXAMPLES

Copolymers of methyl methacrylate (MMA), glycidyl methacrylate (GMA) and ethyl acrylate (EA) (MMA/GMA/EA) of different properties were selected to create the in situ reaction that compatibilises the PVC/PE blends through the epoxy groups that are on the glycidyl methacrylate part of the copolymer.

### Blends Preparation

Polybond® 1009 obtained from Addivant (a high density polyethylene to which carboxylic groups were grafted; in pellet form; melt flow rate (190/2.16): 5-6 g/10 min according to ASTM D-1238; density at 23° C.: 0.95 g/cm³; acrylic acid level 6 wt. %; melting point: 127° C. as measured by Differential Scanning calorimetry), was mixed with SABIC® LLDPE 118N (a butane-linear low density polyethylene resin; melt flow rate (190/2.16): 1.0 g/10 min according to ISO 1133; density according to ISO 1183(A) 918 kg/m³; melding point: 121° C. as measured by Differential Scanning calorimetry) and extruded in pellets form using a Brabender twin screw extruder and the following processing conditions.

### T₁=170° C.

### T₂=180° C.

### T₃=180° C.

### T_{d}=175° C.

Screw speed: 12 rpm
Melt temperature: 185° C.-188° C.

The acrylic copolymers, containing the MMA segments which are miscible with PVC, were mixed with the PVC compound and pelletised using a Brabender twin screw extruder and the following processing conditions.

### T₁=150° C.

### T₂=165° C.

### T₃=175° C.

### T_{d}=175° C.

Screw speed: 12 rpm
Melt temperature: 178° C.-182° C.

The compounds obtained from the mixing of Polybond® 1009 with LLDPE 118N were mixed with the compounds obtained from the mixing of MMA/GMA/EA copolymers with PVC in a manner to obtain blends that contain 70 wt. % of PVC and 30 wt. % of PE. The different blends prepared are shown in table 1.

TABLE 1
PVC/PE (70/30) containing different proportions of chlorinated
polyethylene, Polybond ® 1009 and MMA/GMA/EA copolymers

| | Comp. | Comp. | Inv. | Inv. | Inv. | Inv. | Inv. |
|---|---|---|---|---|---|---|---|
| | Blend A | Blend B | Blend 1 | Blend 2 | Blend 3 | Blend 4 | Blend 5 |
| Material | (wt. %) | (wt. %) | (wt. %) | (wt. %) | (wt. %) | (wt. %) | (wt. %) |
| PVC | 70 | 63.7 | 57.4 | 54.0 | 51.1 | 51.1 | 44.8 |
| PE | 30 | 27.3 | 24.6 | 23.0 | 21.9 | 21.9 | 19.2 |
| MMA/GMA/EA | — | — | 9.0 | 6.9 | — | — | — |
| (83/15/2) | | | | | | | |
| MMA/GMA/EA | — | — | — | — | 9.0 | — | 9.0 |
| (73/25/2) | | | | | | | |
| MMA/GMA/EA | — | — | — | — | — | 9.0 | — |
| Polybond ® | — | — | 9.0 | 6.9 | 9.0 | 9.0 | 9.0 |
| 1009 | | | | | | | |
| CPE Tyrin BH | — | 9.0 | — | 9.0 | 9.0 | 9.0 | 9.0 |
| 9000^{a)} | | | | | | | |

^{a)}CPE Tyrin ™ BH 9000 is a chlorinated polyethylene obtainable from Dow Chemical

ZSK extruder (co-rotating twin screw extruder L/D=26, D=30 mm) having the ability to generate high shear that helps to reduce the size of the dispersed phase for the polymer blends, was used to prepare the blends of table 1 under the following processing conditions:

Temperature zone 1: 150° C.
Temperature zone 2: 175° C.
Temperature zone 3: 170° C.
Temperature zone 4: 180° C.
Adaptor zone: 180° C.

### Temperature die: 160° C.

Melt temperature: 184° C.
Water temperature: 30° C.
Screw speed: 70 rpm
Melt pressure: 2940 atm
Cutter speed: 700 rpm

### Blends Performance Evaluation

The blends performance was evaluated through their mechanical properties (tensile strength and impact strength) and their morphology behaviour. The blend samples used for testing were injection moulded using a Battenfield injection moulding machine under the following conditions.

| | | |
|---|---|---|
| Parameters | Condition 1 | Condition 2 |

| | | | | |
|---|---|---|---|---|
| Temperature zone 1 | 150° | C. | 145° | C. |
| Temperature zone 2 | 165° | C. | 155° | C. |
| Temperature zone 3 | 175° | C. | 165° | C. |
| Nozzle temperature: | 176° | C. | 170° | C. |
| Oil temperature: | 40° | C. | 40° | C. |
| Mould temperature: | 20° | C. | 20° | C. |
| Clamp force: | 1000 | kN | 1000 | kN |
| Injection pressure: | 5.52 | Mpa | 5.52 | Mpa |
| Holding pressure: | 5.52 | Mpa | 5.52 | Mpa |
| Cooling time: | 4 | s | 4 | s |
| Holding time: | 8 | s | 8 | s |
| Injection time: | 8 | s | 8 | s |
| Ejection time: | 1 | s | 1 | s |
| Total cycle time: | 23.6 | s | 23.6 | s |
| Melt temperature: | 190° | C. | 180° | C. |

From table 2 that summarises the mechanical properties of the different characterised blends, it is clearly seen that the blends for which the in situ reaction between the acrylic based copolymer and the carboxylic based polyethylene were used, are performing better. Further improvement is achieved when also chlorinated polyethylene is used in the blend. The considerable improvement of the elongation at break in the presence of both the chlorinated polyethylene and the in situ reaction between the acrylic based copolymer and the carboxylic based polyethylene is attributed to a synergistic effect of the reduction of the size of the polyethylene domains (attributed to the reduction of the surface tension between polyvinylchloride and polyethylene caused by chlorinated polyethylene) and the increase of the interaction forces at the interfaces between the polyethylene domains and the polyvinylchloride matrix.

TABLE 2
Mechanical properties of PVC/PE (70/30) blends

| | Tensile strength | Impact strength | Elongation at |
|---|---|---|---|
| | (MPa) | (J/m) | break (%) |
| Comp. Blend A | 11.4 ± 0.4 | 20.5 ± 1.2 | 2.55 ± 0.35 |
| Comp. Blend B | 18.5 ± 0.6 | 67.0 ± 9.8 | 3.8 ± 0.4 |
| Inv. Blend 1 | 32.4 ± 0.2 | 59.7 ± 16.1 | 12.1 ± 1.7 |
| Inv. Blend 2 | 24.4 ± 0.8 | 88.9 ± 30.0 | 41.3 ± 8.3 |
| Inv. Blend 3 | 25.4 ± 0.7 | 64.4 ± 9.2 | 40.5 ± 7.1 |
| Inv. Blend 4 | 23.7 ± 0.2 | 50.0 ± 3.9 | 41.0 ± 7.2 |
| Inv. Blend 5 | 27.5 ± 0.4 | 65.8 ± 19.5 | 29.5 ± 6.6 |

1. Composition comprising a blend of
(A) polyvinylchloride;
(B) polyolefin modified to have a carboxyl group; and
(C) a copolymer containing a moiety that is miscible with polyvinylchloride and an epoxy group.

2. Composition according to claim 1, wherein said polyolefin modified to have a carboxyl group is a modified polyethylene and/or modified polypropylene.

3. Composition according to claim 1, wherein said moiety that is miscible with polyvinylchloride comprises one or more selected from a polymethylmethacrylate moiety, a nitrile butadiene rubber moiety, a polycaprolactone moiety, a polyethylene vinyl acetate moiety, and a poly(ethylene-vinylacetate-carbon monoxide)terpolymer moiety.

4. Composition according to claim 1, wherein said moiety that is miscible with polyvinylchloride comprises a polymethylmethacrylate moiety.

5. Composition according to claim 1, wherein said epoxy group on the copolymer has undergone a ring-opening reaction with a carboxyl group on the modified polyolefin.

6. Composition according to claim 1, wherein said composition comprises a blend of
(A) the polyvinylchloride in an amount of 40-85 wt. % based on total weight of the blend;
(B) the polyolefin modified to have the carboxyl group in an amount of 3-15 wt. % based on total weight of the blend; and
(C) the copolymer in an amount of 3-15 wt. % based on total weight of the blend.

7. Composition according to claim 1, wherein said blend further comprises
(D) another polyolefin in an amount of 5-35 wt. % based on total weight of the blend.

8. Composition according to claim 7, wherein said another polyolefin is a polyethylene and/or polypropylene.

9. Composition according claim 1, wherein said blend further comprises
(E) chlorinated polyolefin.

10. Composition according to claim 9, wherein said chlorinated polyolefin (E) is a chlorinated polyethylene and/or chlorinated polypropylene.

11. Composition according to claim 1, wherein said copolymer comprises one or more monomers selected from methyl acrylate, methyl methacrylate, ethyl acrylate, ethyl methacrylate, glycidyl acrylate, and glycidyl methacrylate.

12. Composition according to claim 11, wherein said copolymer is a copolymer of methyl methacrylate, glycidyl methacrylate and ethyl acrylate, wherein said methyl methacrylate is present in an amount of 60-85 wt. % based on total weight of said copolymer, wherein said glycidyl methacrylate is present in an amount of 10-40 wt. % based on total weight of said copolymer, and wherein said ethyl acrylate is present in an amount of 1-5 wt. % based on total weight of said copolymer.

13. Article made from a composition according to claim 1.

14. Article according to claim 13 wherein at least part of the carboxyl groups of modified polyolefin (B) have reacted with at least part of the epoxy groups of copolymer (C).

15. Article according to claim 13, having an elongation at break of 10% or more as measured in accordance with ISO 527.

16. Article according to claim 13, having a tensile strength of 20 MPa or more as measured in accordance with ISO 527.

17. Composition comprising a blend of
(A) polyvinylchloride;
(B) polyolefin modified to have a carboxyl group; and
(C) a copolymer containing a moiety that is miscible with polyvinylchloride and an epoxy group;
(E) chlorinated polyolefin.

18. A method of compatibilising a blend of polyvinylchloride and polyolefin, comprising using a compatibiliser comprising a polyolefin modified to have a carboxyl group and a copolymer containing a moiety that is miscible with polyvinylchloride and an epoxy group for compatibilising a blend of polyvinylchloride and polyolefin.

19. Composition according to claim 1,
wherein said composition comprises a blend of
(A) the polyvinylchloride in an amount of 40-80 wt. % based on total weight of the blend;
(B) the polyolefin modified to have the carboxyl group in an amount of 4-12 wt. % based on total weight of the blend; and
(C) the copolymer in an amount of 4-12 wt. % based on total weight of the blend.

20. Composition according to claim 19, wherein said blend further comprises
(D) another polyolefin in an amount of 5-35 wt. % based on total weight of the blend.
